(19) United States
(12) Patent Application Publication
(10) Pub. No.: US 2004/0042173 A1
(43) Pub. Date: Mar. 4, 2004

(54) Electronic apparatus having circulating path through which liquid coolant cooling heat generating component flows

(75) Inventor: Kentaro Tomioka, Sayama-shi (JP)

Correspondence Address: Finnegan, Henderson, Farabow,, Garrett & Dunner, L.L.P., 1300 I Street, N.W., Washington, DC, 20005-3315, US

(73) Assignee: Kabushiki Kaisha Toshiba

(21) Appl. No.: 10/641,168

(22) Filed: Aug. 15, 2003

(30) Foreign Application Priority Data
Aug. 30, 2002 (JP) 2002-255542

(51) Int. Cl. G06F 1/20; F28F 7/00

(52) U.S. Cl. 361/687; 165/80.3; 361/695; 361/702

(57) ABSTRACT

An electronic apparatus includes a main unit having a heat receiving portion which receives heat from a heat generating component, and a display unit supported by the main unit. The display unit accommodates a heat radiating portion. The heat radiating portion is connected to the heat receiving portion via a circulating path. The circulating path allows a liquid coolant to circulate between the heat receiving portion and the heat radiating portion to transfer the heat from the heat generating component to the heat radiating portion. A control device increases the amount of heat transferred from the heat receiving portion to the heat radiating portion when the display unit is moved to a closed position.

### CROSS-REFERENCE TO RELATED APPLICATIONS

This application is based upon and claims the benefit of priority from the prior Japanese Patent Application No. 2002-255542, filed Aug. 30, 2002, the entire contents of which are incorporated herein by reference.

### BACKGROUND OF THE INVENTION

1. Field of the Invention

The present invention relates to an electronic apparatus of the liquid-cooled type, in which a circuit component such as a CPU (Central Processing Unit) is cooled with liquid coolant.

2. Description of the Related Art

A CPU is incorporated in, for example, notebook-type portable computers. The heat that the CPU generates while operating is increasing as its data-processing speed rises, and it performs more and more functions. The higher the temperature of the CPU, the less efficiently it operates. To cool the CPU, so-called cooling systems of the liquid-cooling type have been developed in recent years. A liquid-cooling system uses a liquid coolant that has a far higher specific heat than air.

Japanese Patent Application KOKAI Publication No. 7-142886 discloses a cooling system of the liquid-cooling type, configured for use in a portable computers. The cooling system comprises a heat-receiving header, a heat-radiating header, and a tube for circulating the liquid coolant. The heat-receiving header is accommodated in a housing of the portable computer and thermally connected to the CPU. The heat-radiating header is accommodated in a display unit supported by the housing. The tube is arranged to extend between the housing and the display unit to connect the heat-receiving header and the heat-radiating header together.

With this cooling system, the liquid coolant absorbs heat from the CPU in the heat-receiving header. The liquid coolant thus heated is transferred to the heat-radiating header through the tube. While passing through the heat-radiating header, the liquid coolant releases heat from the CPU. The liquid coolant cooled by the heat-radiating header returns to the heat-receiving header through the tube. Then, the liquid coolant absorbs heat from the CPU again. This circulation of the liquid coolant efficiently transfers heat from the CPU to the heat-radiating header. This serves to improve cooling performance for the CPU compared to common conventional cooling systems of the air-cooling type.

The display unit of the portable computer accommodates a liquid crystal display panel. The liquid crystal display panel is adjacent to the heat-radiating header inside the display unit. Thus, when heat from the CPU is released from the surface of the heat-radiating header, the liquid crystal display panel is unavoidably thermally affected by the heat-radiating header. As is well known, when heated to high temperature, the liquid crystal display panel fails to control the orientation of liquid crystal molecules, resulting in degraded display quality. Thus, the surface temperature of the heat-radiating header, which thermally affects the liquid crystal display panel, must not be thoughtlessly increased. As a result, considering thermal effects on the liquid crystal display panel, the allowable amount of heat released from the heat-radiating header is estimated to be at most between 10 and 20W.

On the other hand, for example, the portable computer may be connected to an external display device having a large screen. In such usage, the liquid crystal display panel of the portable computer stops its display operation. Accordingly, even if the liquid crystal display panel is thermally affected by the heat-radiating header, its display quality is not degraded.

However, the amount of heat released from the heat-radiating header is kept small in order to reduce the thermal effects on the liquid crystal display panel as described above. Thus, the amount of heat released from the heat-radiating header is insufficient both while the liquid crystal display panel is operating and while the display operation remains stopped. Consequently, cooling performance for the CPU may be degraded, which would mean that it cannot sufficiently deal with an increase in the amount of heat generated by the CPU.

### BRIEF SUMMARY OF THE INVENTION

According to an embodiment of the present invention, an electronic apparatus includes a main unit having a heat generating component; a heat receiving portion thermally connected to the heat generating component; a display unit supported by the main unit, which is movable between a closed position and an open position; a heat radiating portion accommodated in the display unit to release the heat from the heat generating component; a circulating path through which a liquid coolant circulates between the heat receiving portion and the heat radiating portion, the circulating path being used to transfer the heat from the heat generating component conducted to the heat receiving portion, to the heat radiating portion via the liquid coolant; and a control device which increases the amount of heat transferred from the heat receiving portion to the heat radiating portion when the display unit is moved to the closed position.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a perspective view of a portable computer according to a first embodiment of the present invention provided with a cooling unit of the liquid cooling type;

FIG. 2 is a perspective view of the portable computer according to the first embodiment of the present invention, showing that a display unit has been rotationally moved to an open position;

FIG. 3 is a side view schematically showing that an external display device is connected to the portable computer according to the first embodiment of the present invention;

FIG. 4 is a sectional view of the portable computer according to the first embodiment of the present invention wherein the cooling unit of the liquid cooling type is mounted in the portable computer;

FIG. 5 is a sectional view of the portable computer according to the first embodiment of the present invention, showing the positional relationship between a CPU and a heat receiving portion;

FIG. 6 is a sectional view of the heat receiving portion according to the first embodiment of the present invention;

FIG. 7 is a sectional view of the portable computer according to the first embodiment of the present invention, showing the positional relationship between an electric fan and a heat radiating portion and a liquid crystal display unit;

FIG. 8 is a sectional view of the heat radiating portion according to the first embodiment of the present invention;

FIG. 9 is a block diagram showing a pump control system according to the first embodiment of the present invention;

FIG. 10 is a flow chart showing what control is provided from the detection of temperature of the CPU until the flow rate of a liquid coolant is increased according to the first embodiment of the present invention; and

FIG. 11 is a flow chart showing what control is provided from the detection of temperature of the CPU until the flow rate of a liquid coolant is increased according to a second embodiment of the present invention.

### DETAILED DESCRIPTION OF THE INVENTION

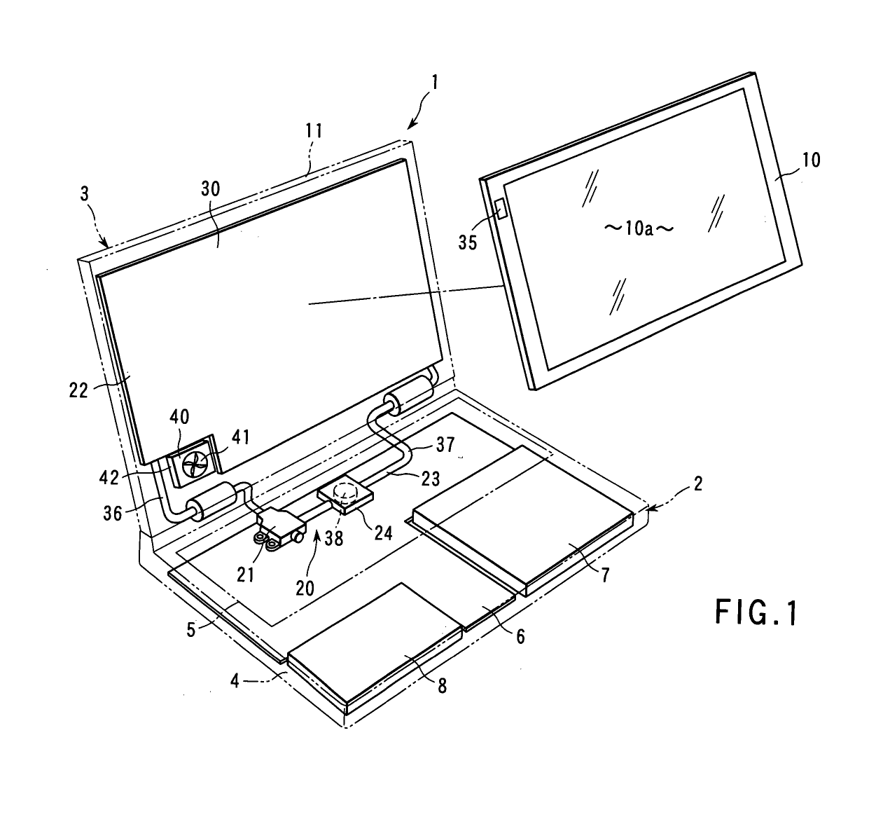

A first embodiment of the present invention will be described below with reference to FIGS. 1 to 10 wherein it is applied to a portable computer.

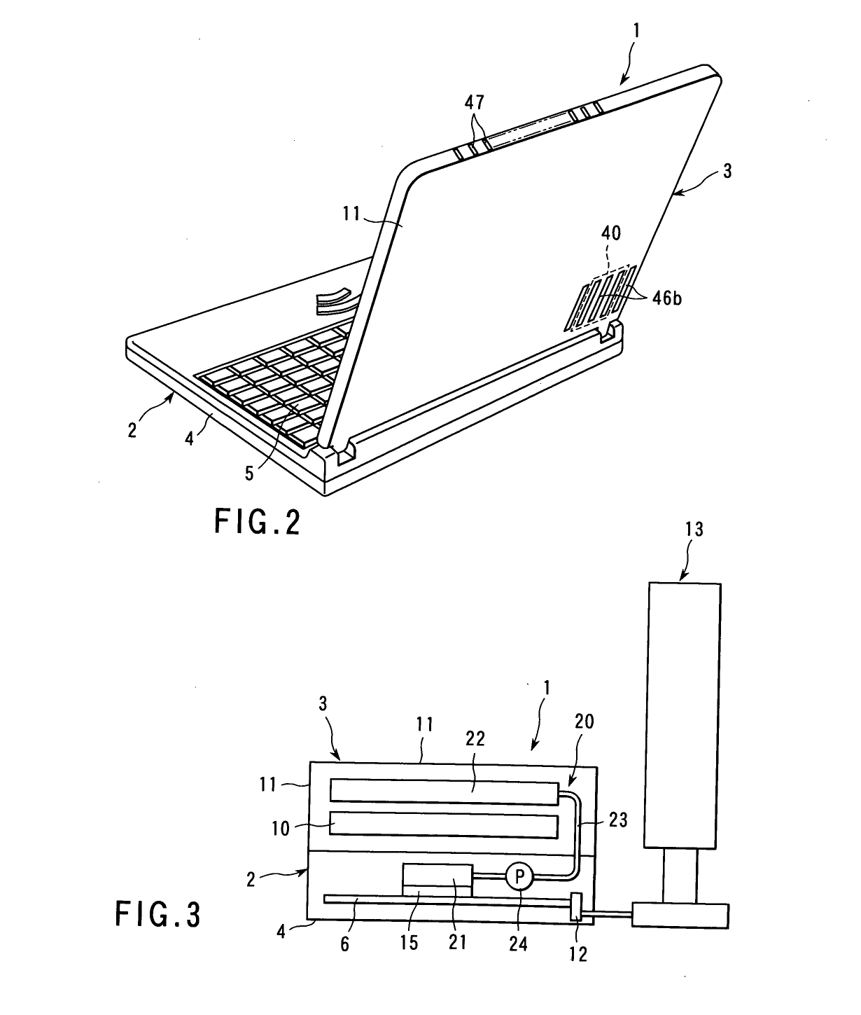

FIGS. 1 and 2 disclose a portable computer 1 as an electronic apparatus. The portable computer 1 comprises a main unit 2 and a display unit 3. The main unit 2 has a housing 4 shaped like a flat box. The housing 4 supports a keyboard 5.

The housing 4 is equipped with a printed circuit board 6, a CD-ROM drive 7, and batteries 8 as a power supply. The printed circuit board 6 and the CD-ROM drive 7 are electrically connected to the batteries 8.

The display unit 3 comprises a liquid crystal display panel 10 and a display housing 11 that accommodates the liquid crystal display panel 10. The liquid crystal display panel 10 has a screen 10a that displays images. The screen 10a is exposed from the display housing 11 through an opening 11a formed in the front surface of the display housing 11. The display housing 11 is supported at the rear end of the housing 4 via hinges (not shown). Thus, the display unit 3 can be rotationally moved between a closed position and an open position. In the closed position, the display unit 3 lies on top of the housing 4, thus covering the keyboard 5 from above. In the open position, the display unit 3 stands up to expose the keyboard 5 and the screen 10a.

The liquid crystal display panel 10 is electrically connected to a liquid crystal driving circuit. The liquid crystal driving circuit is powered off when the display unit 3 is rotationally moved to the closed position. This causes the liquid crystal display panel 10 to stop its display operation. Furthermore, a temperature sensor 35, shown in FIG. 1, is attached to the liquid crystal display panel 10. The temperature sensor 35 detects the temperature of the liquid crystal display panel 10 and outputs a signal for this temperature.

As shown in FIG. 3, an interface connector 12 is mounted at the rear end of the printed circuit board 6. The interface connector 12 is used to connect, for example, an external display device 13 to the portable computer 1. The external display device 13 has a screen (not shown) which is larger than the screen 10a of the display unit 3 and which provides high image quality. If the external display device 13 is connected to the portable computer 1, an operator operates a switch to make a choice as to whether to use the display unit 3 of the portable computer 1 or the external display device 13. If the external display device 13 is chosen, the liquid crystal driving circuit of the liquid crystal display panel 10 is turned off to cause the liquid crystal display panel 10 to stop its display operation.

As shown in FIG. 7, the main unit 2 comprises a position sensor 14. The position sensor 14 electrically detects whether or not the display unit 3 is in the closed position. The position sensor 14 is supported by the top wall 4b of the housing 4. When the display unit 3 is rotationally moved to the closed position, the position sensor 14 detects the presence of the display unit 3 on the basis of the contact between the position sensor 14 and the display housing 11. At the same time, the position sensor 14 outputs a signal indicating that the display unit 3 has been rotationally moved to the closed position.

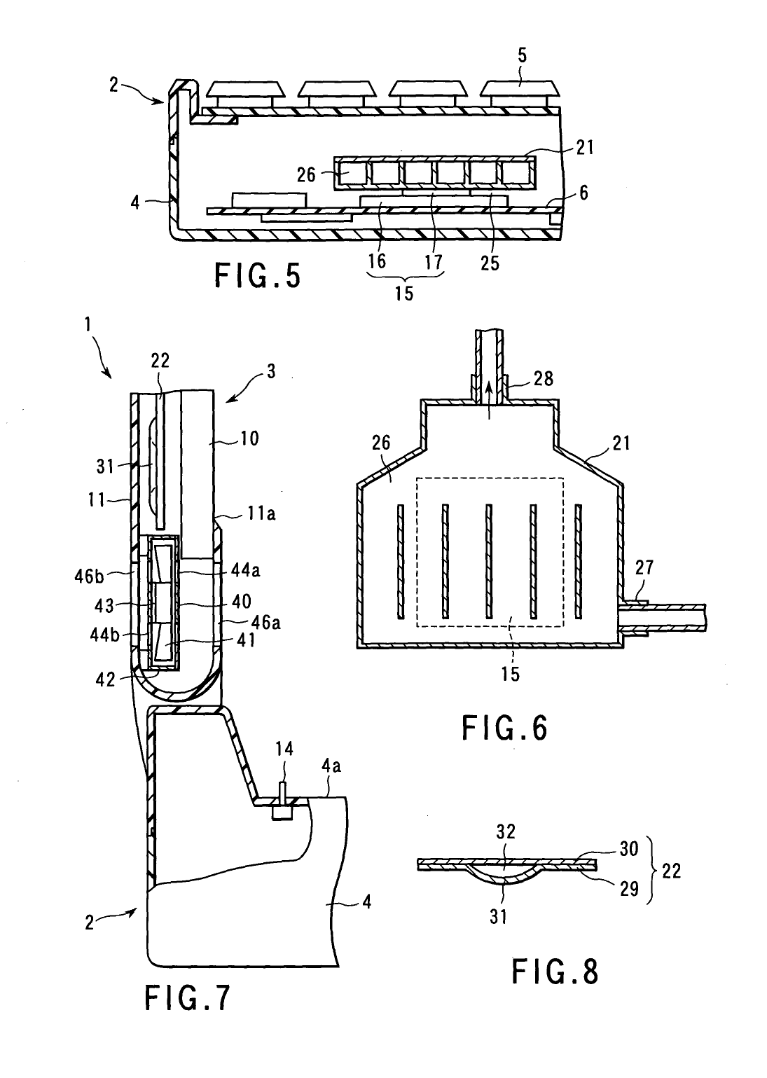

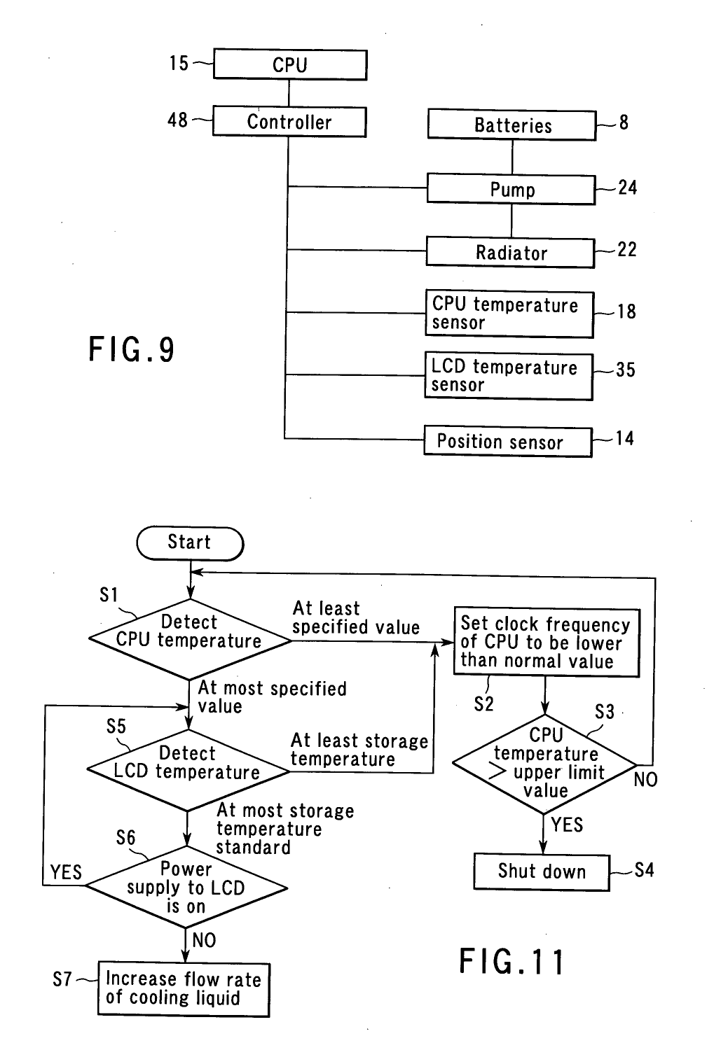

As shown in FIG. 5, a CPU 15 as a heat generating component is mounted on the top surface of the printed circuit board 6. The CPU 15 has a base substrate 16 and an IC chip 17 mounted on the center of the base substrate 16. The IC chip 17 generates a large amount of heat during operation owing to its increased processing speed and the increased number of its functions. The IC chip 17 needs to be cooled to keep operating in stable conditions. The CPU 15 contains a temperature sensor 18 (shown in FIG. 9). The temperature sensor 18 detects the temperature of the IC chip 17 and outputs a signal for this temperature.

As shown in FIGS. 1 and 3, the portable computer 1 is provided with a cooling unit 20 of the liquid cooling type that cools the CPU 15. The cooling unit 20 comprises a heat receiving portion 21, a heat radiating portion 22, a circulating path 23, and a pump 24.

The heat receiving portion 21 is fixed to the printed circuit board 6. As shown in FIG. 5, the heat receiving portion 21 is shaped like a flat box that is a size larger than the CPU 15. The bottom surface of the heat receiving portion 21 constitutes a flat heat receiving surface 25. The heat receiving surface 25 is thermally connected to the IC chip 17 via thermally conductive grease or a thermally conductive sheet (not shown).

The heat receiving portion 21 has a coolant channel 26, an inlet port 27, and an outlet port 28. The coolant channel 26 is formed inside the heat receiving portion 21 and thermally connected to the IC chip 17 via the heat receiving surface 25. The inlet port 27 is located at the upstream end of the coolant channel 26. The outlet port 28 is located at the downstream end of the coolant channel 26.

As shown in FIG. 7, the heat radiating portion 22 is accommodated in the display housing 11 of the display unit 3. The heat radiating portion 22 is shaped like a rectangular plate substantially as large as the liquid crystal display panel 10. The heat radiating portion 22 is arranged between the liquid crystal panel 10 and the rear surface of the display housing 11. Thus, the heat radiating portion 22 is adjacent to the liquid crystal display panel 10 inside the display housing 11.

As shown in FIG. 8, the heat radiating portion 22 comprises a first radiator plate 29 and a second radiator plate 30. The first and second radiator plates 29 and 30 are each made of metal and are superimposed on each other. The first radiator plate 29 has a bulging portion 31 extending away from the second radiator plate 30. The bulging portion 31 meanders substantially all over the surface of the first radiator plate 29. It also opens toward the second radiator plate 30. An opening end of the bulging portion 31 is closed by the second radiator plate 30. The bulging portion 31 of the first radiator plate 29 constitutes a coolant channel 32 between itself and the second radiator plate 30.

The heat radiating portion 22 has an inlet port 33 and an outlet port 34. The inlet port 33 is located at the upstream end of the coolant channel 32. The outlet port 34 is located at the downstream end of the coolant channel 32. The inlet port 33 and the outlet port 34 are spaced from each other in the width direction of the display housing 8.

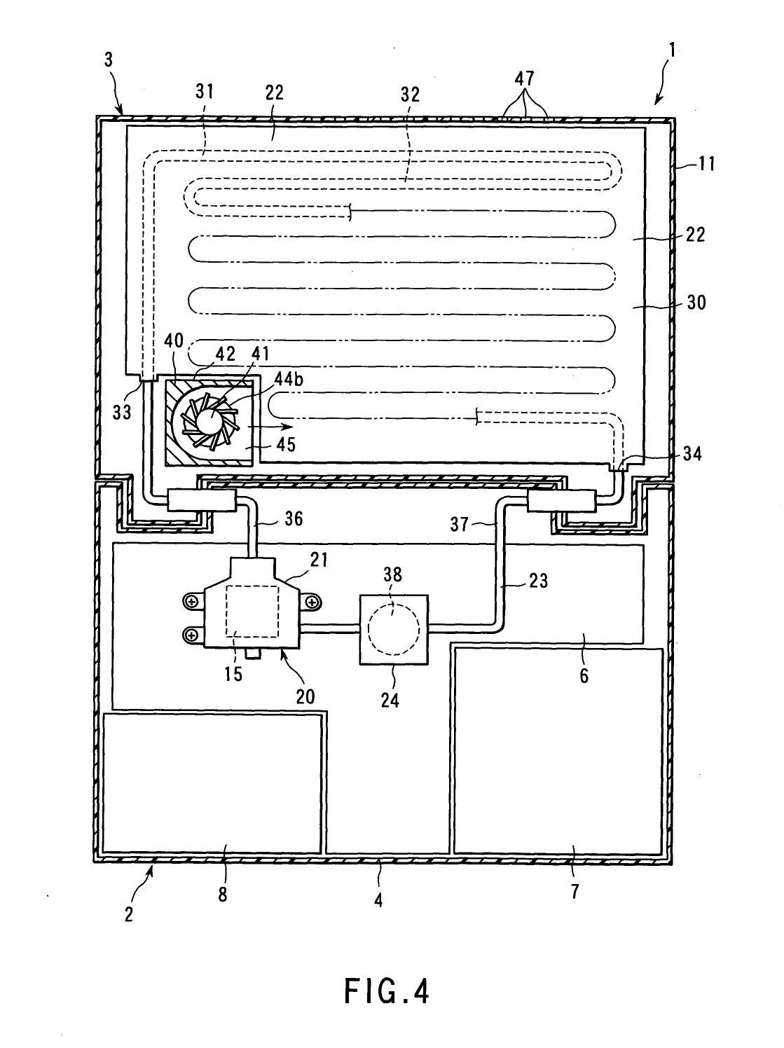

As shown in FIGS. 1 and 4, the circulating path 23 comprises two pipes 36 and 37. The first pipe 36 extends between the housing 4 and the display housing 11 so as to connect the outlet port 28 of the heat receiving portion 21 and the inlet port 33 of the heat radiating portion 22 together. The second pipe 37 extends between the housing 4 and the display housing 11 so as to connect the outlet port 34 of the heat radiating portion 22 and the inlet port 27 of the heat receiving portion 21 together. Thus, the coolant channel 26 in the heat receiving portion 21 and the coolant channel 32 in the heat radiating portion 22 are connected together via the circulating path 23. The circulating path 23 and the coolant channels 26 and 32 are filled with a liquid coolant.

The pump 24 is installed in the middle of the second pipe 37. The pump 24 is used to forcibly circulate the liquid coolant between the heat receiving portion 21 and the heat radiating portion 22. In the present embodiment, the pump 24 is accommodated in the housing 4. The pump 24 has an impeller 38 driven by a motor (not shown). The impeller 38 starts to be driven, for example, when the portable computer 1 is powered on or when the temperature of the CPU 15 reaches a predetermined value. The motor for the pump 24 is electrically connected to the batteries 8, accommodated in the housing 4. The rotation speed of the impeller 38 is varied by varying a voltage supplied to the motor.

When the impeller 38 of the pump 24 is rotated, the liquid coolant is delivered from the pump 24 to the heat receiving portion 21. The liquid coolant then flows along the circulating path 23. More specifically, the liquid coolant filled into the coolant channel 26 of the heat receiving portion 21 absorbs heat from the CPU 15 while flowing through the coolant channel 26. The liquid coolant thus heated is delivered to the heat radiating portion 22 through the first pipe 36. It then flows through the coolant channel 32. While the liquid coolant is flowing through the channel 32, the heat from the CPU 15 absorbed by the liquid coolant is diffused to the first and second radiator plates 29 and 30. The heat is then released from the surfaces of the radiator plates 29 and 30.

The liquid coolant is cooled by heat exchange in the heat radiating portion 22. It then returns to the coolant channel 26 of the heat receiving portion 21 via the second pipe 37. The liquid coolant absorbs heat from the CPU 15 again while flowing through the coolant channel 26. It is then delivered to the heat radiating portion 22. The repetition of such a cycle allows heat from the CPU 15 to be transferred to the heat radiating portion 22. The heat is released from the heat radiating portion 22 to the exterior of the portable computer 1 through the display housing 11.

As shown in FIGS. 1, 4, and 7, an electric fan 40 is accommodated in the display housing 11 of the display unit 3. The electric fan 40 is used to blow a cooling air against the heat radiating portion 22. It is located at the lower end of left side of the heat radiating portion 22.

The electric fan 40 comprises a centrifugal impeller 41 and a fan casing 42 in which the impeller 41 is accommodated. The impeller 41 starts to be driven by a motor 43, for example, when the portable computer 1 is powered on.

The fan casing 42 has first and second suction ports 44a and 44b and an ejection port 45. The first suction port 44a lies opposite first intake holes 46a opened in the front surface of the display housing 11. The second suction port 44b lies opposite second intake holes 46b opened in the rear surface of the display housing 11. The ejection port 45 opens toward the heat radiating portion 22.

When the impeller 41 of the electric fan 40 is rotated, the air present outside the display unit 3 is sucked into the first and second suction ports 44a and 44b of the fan casing 42 through the first and second intake holes 46a and 46b, respectively. The sucked air is ejected from the ejection port 45 toward the heat radiating portion 22.

As a result, the flow of a cooling air is formed inside the display housing 11. This cooling air forcibly cools the heat radiating portion 22. Heat from the CPU 15 conducted to the heat radiating portion 22 is carried away by the flow of the cooling air. The cooling air heated by the heat exchange between itself and the heat radiating portion 22 is discharged to the outside of the display unit 3 from vents 47 opened at the upper end of the display housing 11.

In the present embodiment, the electric fan 40 continues its operation even after the display unit 3 is rotationally moved to the closed position, unless the portable computer 1 is powered off. Further, when the display unit 3 is rotationally moved from the closed position to the open position, the electric fan 40 is controlled to increase the rotation speed of the impeller 41.

The portable computer 1 configured as described above incorporates a program that serves to increase the amount of heat released from the heat radiating portion 22 when the display unit 3 is rotationally moved to the closed position.

FIG. 9 is a block diagram showing operation control of the pump 24. As shown in FIG. 9, a controller 48 receives a signal for the temperature of the CPU 15, which is outputted by the temperature sensor 18, a signal for the temperature of the liquid crystal display panel 10 which is outputted by the temperature sensor 35, and a signal indicating whether or not the display unit 3 is in the closed position, the signal being outputted by the position sensor 14. The controller 48 is controlled by the CPU 15. The controller 48 determines the current operational status of the portable computer 1 on the basis of various inputted signals. The controller 48 thus controls the operation of the pump 24.

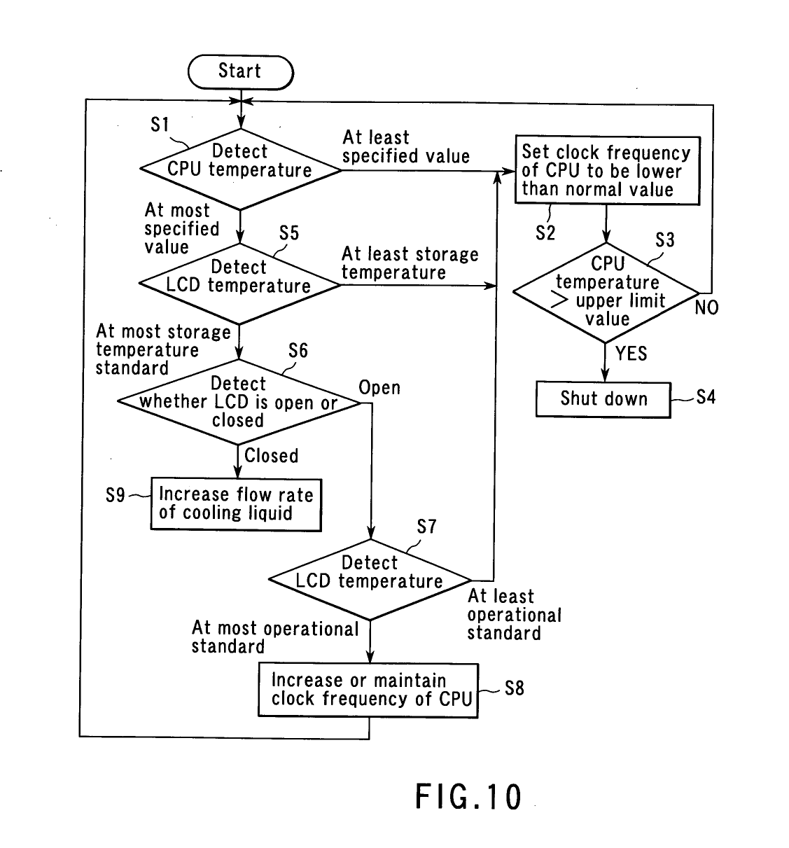

FIG. 10 is a flow chart showing a procedure of increasing the flow rate of the liquid coolant flowing through the circulating path 23 on the basis of operational status of the portable computer 1.

While the portable computer 1 is in operation, the temperature of the CPU 15 is first detected via the temperature sensor 18 in the first step S1. The signal for the temperature of the CPU 15 is inputted to the controller 48. The controller 48 determines whether or not the temperature of the CPU 15 is within a predetermined specified range.

If it is determined in step S1 that the temperature of the CPU 15 exceeds the specified range, the procedure proceeds to step S2. In step S2, a process is executed to set the clock frequency of the CPU 15 to be lower than a normal value to reduce the amount of heat generated by the CPU 15. In the next step S3, the temperature of the CPU 15 is monitored after the clock frequency has decreased. The temperature of the CPU 15 is then compared with a predetermined upper limit value. If the temperature of the CPU 15 is lower than the upper limit value, the procedure returns to step S1 to repeat a process of detecting the temperature of the CPU 15. In step S3, if the temperature of the CPU 15 exceeds the upper limit value, the procedure proceeds to step S4. In step S4, the controller 48 executes a process of shutting down the portable computer 1.

On the other hand, if it is determined in step S1 that the temperature of the CPU 15 is lower than the specified value, the procedure proceeds to step S5. In step 5, the temperature sensor 35 detects the temperature of the liquid crystal display panel 10. The signal for the temperature of the liquid crystal display 10 is inputted to the controller 48. The controller 48 determines whether or not the temperature of the liquid crystal display panel 10 is within the standard range of temperatures at which the display panel 10 should be stored.

If the temperature of the liquid crystal display panel 10 exceeds the standard for the storage temperature, the controller 48 determines that the liquid crystal display panel 10 is significantly thermally affected by the heat radiating portion 22. Then, the procedure shifts to the above step S2. The CPU 15 is thus prevented from generating heat, reducing the amount of heat transferred from the heat receiving portion 21 to the heat radiating portion 22. This suppresses an increase in the temperature of the heat radiating portion 22.

If the temperature of the liquid crystal display panel 10 is lower than the standard for the storage temperature, the procedure proceeds to step S6. In step S6, it is determined whether or not the display unit 3 is in the closed position. If it is determined in step S6 that the display unit 3 is in the open position, then at the next step S7, a process is executed to detect the temperature of the liquid crystal display panel 10.

In step S7, if it is determined that the temperature of the liquid crystal display panel 10 exceeds the operational standard, the controller 48 determines that the liquid crystal display panel 10 is significantly thermally affected by the heat radiating portion 22. The procedure then shifts to the above step S2. The CPU 15 is thus prevented from generating heat, reducing the amount of heat transferred from the heat receiving portion 21 to the heat radiating portion 22. This suppresses an increase in the temperature of the heat radiating portion 22.

If it is determined in step S7 that the temperature of the liquid crystal display panel 10 is lower than the operational standard, the procedure proceeds to step S8. In step S8, the controller 48 executes a process of increasing the clock frequency of the CPU 15 or a process of maintaining the clock frequency if it has already reached its limit.

If it is determined in step S6 that the display unit 3 is in the closed position, the procedure proceeds to step S9. In step S9, a process is executed to increase the flow rate of the liquid coolant flowing through the circulating path 23. Specifically, the controller 48 controls the operation of the pump 24 to increase a voltage supplied to the motor for the pump 24. This increases the rotation speed of the impeller 38 and thus the amount of liquid coolant ejected per unit time. Therefore, the amount of liquid coolant delivered from the pump 24 to the heat receiving portion 21 increases, thus increasing the amount of heat transferred from the heat receiving portion 21 to the heat radiating portion 22.

According to the first embodiment of the present invention, when the display unit 3 is rotationally moved to the closed position, the liquid crystal display panel 10 stops its display operation. Further, the rotation speed of impeller 38 of the pump 42 increases. This increases the flow rate of liquid coolant flowing from the heat receiving portion 21 to the heat radiating portion 22 and thus the amount of heat transferred from the heat generating portion 21 to the heat radiating portion 22. As a result, the surface temperatures of the first and second radiator plates 29 and 30 increase to enhance the radiating performance of the heat radiating portion 22.

In other words, the radiating performance of the heat radiating portion 22 is improved only while the liquid crystal display panel 10 stops its display operation. Thus, the display quality of the liquid crystal display panel 10 is not degraded even if the display panel 10 is significantly thermally affected by the heat radiating portion 22. Consequently, even though the heat radiating portion 22 and the liquid crystal display panel 10 are adjacent to each other, it is possible to increase the amount of heat released from the heat radiating portion 22 to enhance the cooling performance for the CPU 15.

According to the above configuration, the electric fan 40 is accommodated in the display housing 11 of the display unit 3. The electric fan 40 blows the cooling air against the heat radiating portion 22 to positively cool the heat radiating portion 22 by the cooling air. As a result, the surface temperature of the heat radiating portion 22 decreases to reduce the thermal effects of the heat radiating portion 22 on the liquid crystal display panel 10.

In particular, in the present embodiment, when the display unit 3 is rotationally moved from the closed position to the open position while the power supply to the portable computer 1 is on, the rotation speed of the impeller 41 increases. This increases the amount of cooling air blown against the heat radiating portion 22. It is thus possible to positively cool the heat radiating portion 22 before the liquid crystal display panel 10 resumes its display operation. Consequently, the atmospheric temperature of the liquid crystal display panel 10 can be reduced in a short time to properly maintain the display quality of the liquid crystal display panel 10.

In the above first embodiment, when the display unit 3 is rotationally moved to the closed position, the amount of heat released from the heat radiating portion 22 is increased. However, the present invention is not limited to this aspect. FIG. 11 shows a second embodiment of the present invention.

The second embodiment differs from the first embodiment in that the amount of heat released from the heat radiating portion 22 is increased while the power supply to the liquid crystal driving circuit is off. The other basic arrangements of the portable computer 1 are similar to those of the first embodiment.

FIG. 11 is a flow chart showing a procedure of increasing the flow rate of the liquid coolant flowing through the circulating path 23 on the basis of usage of the portable computer 1. In FIG. 11, the processing executed between steps S1 to 5S is similar to that in the first embodiment. The processing after step 5S differs from that in the first embodiment.

In the second embodiment, if the temperature of the liquid crystal display panel 10 detected in step S5 is lower than the standard for the storage temperature, the procedure proceeds to step S6 to detect whether or not the power supply to the liquid crystal driving circuit of the liquid crystal display panel 10 is off.

Specifically, after the external display device 13 has been connected to the portable computer 1, when the operator chooses the use of the external display device 13, the liquid crystal driving circuit is powered off. Then, the liquid crystal display panel 10 stops its display operation. Thus, in step S6, the condition of the power supply to the liquid crystal driving circuit is detected. If it is determined that the power supply is off, the procedure shifts to step S7 to increase the flow rate of the liquid coolant flowing through the circulating path 23. Control executed to increase the flow rate of the liquid coolant is similar to that in the first embodiment.

If it is determined in step S6 that the power supply to the liquid crystal driving circuit is on, the procedure returns to step S5 to repeat a process of detecting the temperature of the liquid crystal display panel 10.

Also in the second embodiment, the radiating performance of the heat radiating portion 22 can be enhanced only while the liquid crystal display panel 10 stops its display operation. Accordingly, the cooling performance for the CPU 15 can be enhanced without degrading the display quality of the liquid crystal display panel 10.

In the above first embodiment, the pump is accommodated in the housing of the main unit. However, the present invention is not limited to this aspect. The pump may be accommodated in the display housing of the display unit.

Furthermore, the electric fan is not an essential component and may thus be omitted.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
a main unit having a heat generating component;
a heat receiving portion thermally connected to the heat generating component;
a display unit supported by the main unit, which is movable between a closed position and an open position;
a heat radiating portion accommodated in the display unit to release the heat from the heat generating component;
a circulating path through which a liquid coolant circulates between the heat receiving portion and the heat radiating portion, the circulating path being used to transfer the heat from the heat generating component conducted to the heat receiving portion, to the heat radiating portion via the liquid coolant; and
a control device which increases the amount of heat transferred from the heat receiving portion to the heat radiating portion when the display unit is moved to the closed position.

2. The electronic apparatus according to claim 1, wherein the circulating path includes a pump which delivers the liquid coolant, and the control device controls the pump so as to increase the flow rate of the liquid coolant delivered by the pump when the display unit is moved to the closed position.

3. The electronic apparatus according to claim 2, wherein the pump has an impeller, and the control device controls the pump so as to increase the rotation speed of the impeller when the display unit is moved to the closed position.

4. The electronic apparatus according to claim 1, further comprising a fan accommodated in the display unit to blow a cooling air against the heat radiating portion.

5. The electronic apparatus according to claim 4, wherein the fan is controlled to increase the amount of cooling air blown against the heat radiating portion when the display unit is moved to the open position.

6. The electronic apparatus according to claim 1, wherein the heat radiating portion is adjacent to the display panel inside the display unit.

7. An electronic apparatus comprising:
a main unit having a heat generating component;
a heat receiving portion thermally connected to the heat generating component;
a display unit supported by the main body and having a display panel;
a heat radiating portion accommodated in the display unit to release the heat from the heat generating component;
a circulating path through which a liquid coolant circulates between the heat receiving portion and the heat radiating portion, the circulating path being used to transfer the heat from the heat generating component conducted to the heat receiving portion, to the heat radiating portion via the liquid coolant; and
a control device which increases the flow rate of the liquid coolant flowing through the circulating path when the display panel is turn off.

8. The electronic apparatus according to claim 7, wherein the circulating path includes a pump which delivers the liquid coolant, and the control device controls the pump so as to increase the flow rate of the liquid coolant delivered by the pump when the display panel stops the display operation.

9. The electronic apparatus according to claim 7, wherein the display unit is rotatable between a closed position in which the display unit lies on top of the main unit and an open position in which the display unit stands up from the main unit, and the display panel stops its display operation when the display unit is rotated to the closed position.

10. The electronic apparatus according to claim 7, further comprising an external display device electrically connected to the main unit, and wherein the display panel stops its display operation when the external display device is connected to the main unit.

11. The electronic apparatus according to claim 7, wherein the heat generating component is a CPU, the CPU has a temperature sensor which detects the temperature of the CPU, and the control device determines whether or not the temperature of the CPU exceeds a predetermined specified value, the control device setting a clock frequency of the CPU to be lower than a normal value when the temperature of the CPU exceeds the specified values.

12. The electronic apparatus according to claim 11, wherein the control device monitors the temperature of the CPU after the clock frequency of the CPU has been reduced below the normal value, and executes a shutdown process when the temperature of the CPU is higher than a predetermined upper limit value.

13. The electronic apparatus according to claim 7, wherein the heat radiating portion is adjacent to the display panel inside the display unit.
